(19) United States
(12) Patent Application Publication
(10) Pub. No.: US 2025/0017128 A1
(43) Pub. Date: Jan. 16, 2025

(54) METHOD FOR THE REMOTE CONTROL OF FUNCTIONS OF A WORKING MACHINE OR OF ATTACHMENTS COUPLED THERETO

(71) Applicant: Reichhardt GmbH Steuerungstechnik, Hungen (DE)

(72) Inventor: Rachid SOUSSI, Giessen (DE)

(73) Assignee: Reichhardt GmbH Steuerungstechnik, Hungen (DE)

(21) Appl. No.: 18/769,887

(22) Filed: Jul. 11, 2024

(30) Foreign Application Priority Data
Jul. 11, 2023 (DE) 10 2023 118 350.8

(51) Int. Cl. A01B 76/00

(52) U.S. Cl. CPC A01B 76/00

(57) ABSTRACT

In a method for controlling at least one AUX function of an agricultural machine with a first device including a CAN-Wifi module, a data-exchanging connection is established between the first device and the agricultural machine, wherein the CAN wifi module registers as an ISOBUS client with VT mask and AUX inputs and outputs on the ISOBUS of the agricultural machine in accordance with ISO11783, a WLAN connection is established to a mobile terminal with a user interface for displaying machine-specific information and inputting machine-specific commands, or a WLAN connection is established to a second device on another agricultural machine with a user interface for displaying machine-specific information and inputting machine-specific commands, inputs on the user interface are transmitted to the CAN-Wifi module via the WLAN connection, the CAN-Wifi module generates a machine-specific command in accordance with ISO11783 on the ISOBUS and triggers AUX functions on the agricultural machine.

### CROSS REFERENCE TO RELATED APPLICATIONS

Applicant claims priority under 35 U.S.C. § 119 of German Application No. 10 2023 118 350.8 filed Jul. 11, 2023, the disclosure of which is incorporated by reference.

### BACKGROUND OF THE INVENTION

### 1. Field of the Invention

The invention relates to a method for controlling at least one AUX function of an agricultural machine with a mobile terminal and a system for carrying out the method.

### 2. Description of the Related Art

Agricultural machinery, in particular motor-driven vehicles for agriculture and forestry and associated implements, often have a programmable electronic control unit for controlling and regulating various drive and implement components. The control unit is connected to actuators and any attached devices via the machine's own network or control bus system and has a user interface on which control commands and control parameters can be entered or selected. The user interface allows the input of setpoints for certain parameters and has a graphical display panel on which entered setpoints and working parameters and function signals of the machine measured by sensors can be displayed. In many cases, the display panel is also equipped with a touch input function to facilitate the input of various parameters. In agricultural vehicles and mobile agricultural machinery, control bus systems and user interfaces are often used in accordance with the ISO 11783 standard, which is widely known as ISOBUS.

DE 10 2014 211 712 A1 discloses an arrangement for controlling an implement interface of an agricultural work vehicle, comprising a control unit of the work vehicle, which is in controlling connection with a power-operated actuator for adjusting the position of the implement interface, and a portable computer with input means and a processor, which is in wireless communication connection with the control unit and on which software is downloaded, which enables control of the actuator by means of the input means via the processor and the control unit.

The user interface can be a “Universal Terminal” (UT), a human-machine interface to the ISOBUS. The UT usually has a display screen and operating elements. Each implement that is connected to the ISOBUS logs on to the UT and loads an object pool onto the UT. Information about the respective device can be viewed and settings can be made via the object pool. A disadvantage, however, is that the UT often has a low resolution and no longer meets today's technical standards, especially with older agricultural machinery. The UT is mounted on one side of the driver's cab and its position cannot be changed. This has the major disadvantage that the driver of the agricultural machine cannot see and operate the UT optimally or at all, depending on his sitting position. The driver can make use of other operating elements, such as a joystick, which can usually also be positioned in different positions so that they are accessible to the driver. However, these operating elements do not include any visual display means and are only intended for operating the agricultural machine or the implements. Such control units are machine-bound due to their cabling. The user must be on the machine in order to be able to control functions via a joystick, for example.

On the agricultural machine, the assignment of AUX inputs (buttons) to AUX outputs (functions) is managed via an ISO UT. According to the ISO11783standard, AUX inputs and outputs can be labeled as ‘Single’ or ‘Multi assignable’. For some operations, the farmer must dismount from the machine, for example to check the implement (e.g. checking the nozzle function of a sprayer). He then climbs back on and makes any necessary adjustments using a joystick function. He may then have to dismount again to check the result. For other operations, another machine is added, which is controlled by at least one other person. Interaction then takes place between the working machines, which must be carried out in addition to the actual work activity (e.g. overloading process during a harvesting activity).

The problem with the known devices and methods is that the work processes sometimes take a very long time, as the farmer/worker often has to climb down and up again to control functions from the cab of the working machine. This places a high workload on the harvester driver, as he has to focus on several work processes simultaneously (e.g. controlling the harvester and managing the transfer process at the same time). ‘Single assignable’ (of AUX functions) means that only one assignment of the respective input/function is possible. This means that functions can only be controlled by one specific operating unit. Reconfiguration is usually complicated. In addition, only AUX functions of a working machine can be controlled if corresponding outputs are available (an attachment is connected).

### SUMMARY OF THE INVENTION

The invention is based on the task of providing a method with which remote control of an agricultural machine is possible, at least for individual commands.

The problem is solved by one embodiment of the invention. Preferred embodiments are described in the dependent claims.

According to the invention, the problem is solved by providing a method for controlling at least one AUX function of an agricultural machine with a first device comprising a CAN wifi module, comprising the steps:

Establishment of a data-exchanging connection between the first device and the agricultural machine, whereby the CAN-Wifi module registers as an ISOBUS client with VT mask and AUX inputs and outputs on the ISOBUS of the agricultural machine in accordance with ISO11783, a WLAN connection is established to a mobile terminal with a user interface for displaying machine-specific information and entering machine-specific commands, or a WLAN connection is established to a second device on another agricultural machine with a user interface for displaying machine-specific information and entering machine-specific commands,
inputs on the user interface are transmitted to the CAN-Wifi module via the WLAN connection,
the CAN-Wifi module generates a machine-specific command according to ISO11783 on the ISOBUS and triggers AUX functions on the agricultural machine. The method according to the invention enables the remote control of functions of an agricultural machine alone and any implements coupled to it on the basis of the ISOBUS according to ISO 11783. For the purposes of the invention, an agricultural machine comprises an agricultural working machine alone or together with one or more implements.

The device establishes a wireless or wired connection to the agricultural machine. Furthermore, a wireless connection is established between the device, in particular its CAN-WiFi module, which logs on to the ISOBUS of the agricultural machine as an ISOBUS client with VT and AUX-N functionality, and a mobile terminal. The mobile terminal device is preferably designed as a terminal device that can be carried in one hand and has a touch-sensitive screen. The terminal device can be, for example, a laptop, a tablet computer, a smartphone or another mobile electronic device, which advantageously has a touch-sensitive screen and which has the hardware interfaces required for the connection with the CAN WiFi module. A preferred connection is a W-LAN connection, but cable-free connections are also possible.

In particular, the invention relates to a method for controlling at least one AUX function of an agricultural machine with a mobile terminal, comprising the steps of:

Establishment of a data-exchanging connection between the mobile terminal and a CAN-Wifi module of the agricultural machine, whereby the CAN-Wifi module registers as an ISOBUS client with VT mask and AUX inputs and outputs on the ISOBUS of the agricultural machine in accordance with ISO11783, a user interface for displaying machine-specific information and entering machine-specific commands is available on the mobile end device and inputs on the user interface are transmitted to the CAN-Wifi module via the connection, the CAN-Wifi module generates a machine-specific command on the ISOBUS in accordance with ISO11783 and triggers AUX functions on the agricultural machine

The mobile end device is connected to the CAN-WiFi module via cable-free communication means for data exchange, so that data can be exchanged via the communication link and machine-specific information can be displayed and machine-specific commands can be entered via the mobile end device.

The user interface on the end device can be provided by a program installed on the end device, in particular an app. However, the user interface can also be provided by a web interface. The user interface can reflect a function assignment. This allows a button press on the end device to be transmitted to the CAN-WiFi module via WLAN, for example. This can then generate a message on the ISOBUS in accordance with ISO11783 and trigger control of advantageously assigned AUX functions on the agricultural machine or, for example, an implement.

Alternatively, a second device is connected to another agricultural machine to exchange data and the first and second devices communicate with each other via a WLAN connection. The other agricultural machine has a user interface for displaying machine-specific information and entering machine-specific commands. The two devices communicate with each other, whereby AUX functions can be triggered in the other agricultural machine via the devices.

Inputs on the user interface can also be made using control elements. For example, a joystick can be used as a control element.

The method according to the invention can shorten the duration of work processes and an operator of the agricultural machine no longer has to enter the cab of the machine to be able to control an AUX function. The operator is relieved by no longer having to concentrate on several processes.

Advantageously, the triggering of AUX functions on the agricultural machine is enabled. For example, the driver of the agricultural machine can remain in the driver's cab and another person can control the AUX functions from outside the agricultural machine. Such an authentication process ensures that no unintentional control of machine functions can take place. Depending on the configuration, authorization can be granted once for each existing connection. However, it may also be preferable for each AUX function to be enabled.

It is advantageous for single assignment functions to be assigned by an operating element of the agricultural machine to corresponding AUX inputs and outputs of the CAN Wifi module, so that an input on the operating element triggers an input on the CAN Wifi module and leads to a machine-specific command. Single assignment functions can be assigned to the CAN-Wifi module by a joystick, for example. An input to the joystick, for example, then triggers an input from the CAN-Wifi module, which leads to control of the agricultural machine. This means that functions can be controlled via a control element, but also via the user interface of the mobile end device.

Advantageously, the ISO client with VT and AUX function is located on the agricultural machine, i.e. it is connected to it, so that the connection on the ISOBUS cannot simply be interrupted (fail-safe).

Functions can be assigned once to preferred AUX inputs and AUX outputs.

It is preferred that the CAN-Wifi module simulates the registration of an implement with corresponding outputs on the ISOBUS, so that physical inputs are assigned to simulated outputs. Hardware present on the agricultural machine, in particular the CAN Wifi module, can simulate the registration of an implement with outputs. This makes it possible to assign physical inputs to simulated outputs of the simulated implement. The control of the outputs enables the control of functions on the agricultural machine (e.g. switching on the PTO shaft) without a physical implement having to be coupled.

It is also preferred that the device records and repeatedly executes machine-specific commands entered via the user interface. The user interface can be available on a mobile device, for example, or the corresponding program or web interface can have a sequence control function or macro function. A sequence of button presses can therefore be recorded via the user interface. This sequence can then be played back as a sequence. The user does not have to press every button himself.

Furthermore, the invention relates to a system for carrying out the method, with at least one agricultural machine, a first device and a second device or a mobile terminal with a user interface for displaying machine-specific information and inputting machine-specific commands, which have hardware interfaces for data-exchanging communication and the devices, which comprise a CAN-Wifi module, are connected or can be connected to at least the one agricultural machine. In particular, the invention relates to a system for carrying out the method with an agricultural machine and a mobile terminal which have hardware interfaces for data-exchanging communication and a device which comprises a CAN wifi module and is connected or connectable to the agricultural machine. In particular, the mobile terminal also comprises a CAN-Wifi module.

The first and second device can, for example, be designed as a dongle that can be connected to a corresponding data port on the agricultural machine. For the sake of simplicity, the plural is not used in the following, but the embodiments described are applicable to both devices.

The device advantageously comprises an ISOBUS client with VT mask and AUX inputs and outputs. These can, for example, be present on the CAN Wifi module of the device. In particular, the device comprises a programmable computing unit. The device comprises hardware interfaces for wireless and/or cable-free communication. In particular, the device comprises at least one WLAN interface for data-exchanging communication with a mobile end device.

### BRIEF DESCRIPTION OF THE DRAWINGS

The invention is explained in more detail below with reference to embodiments of the invention, which are shown in the drawing. It shows

FIG. 1 is a schematic communication between a terminal and an agricultural machine,

FIG. 2 is a schematic communication between a combination,

FIG. 3 is a schematic data flow according to one embodiment of the method,

FIG. 4 is a schematic data flow according to the state of the art and

FIG. 5 is a schematic representation of a multi-assignment.

### DETAILED DESCRIPTION OF PREFERRED EMBODIMENTS

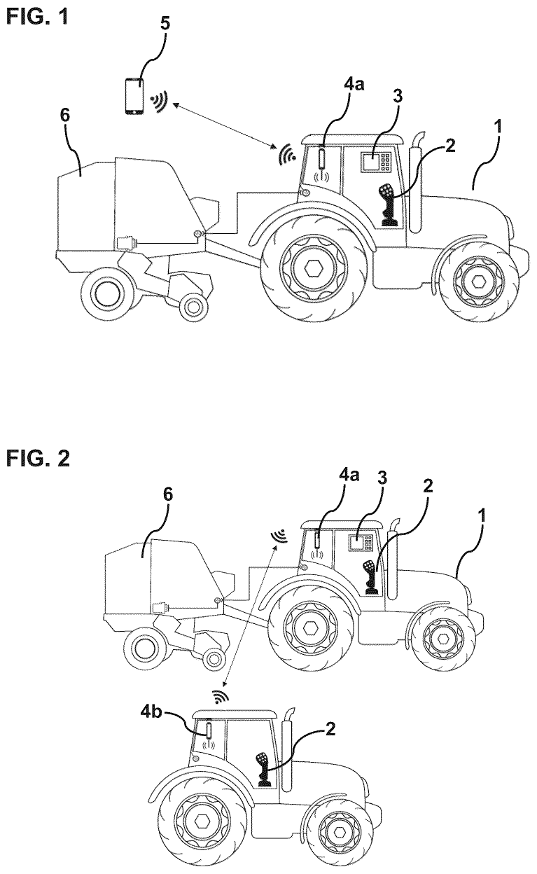

FIG. 1 shows a schematic communication between a terminal device and an agricultural machine. The agricultural machine 1, referred to as the main unit in the context of the invention, represents the machine to be controlled or the combination (towing vehicle with ISOBUS implement). For the purposes of the invention, agricultural machine 1 is also referred to as an agricultural machine with an implement. A combination is used as an alternative.

An operating element 2 can be present on the agricultural machine 1 as an “input unit” (e.g. a joystick), which is also used to control machine functions via ISOBUS. There is also an ISO UT 3, which manages the assignment of AUX inputs and outputs in accordance with ISO 11783, which can come from the control element 2, for example. A first device 4a, which has a CAN wifi module, is designed here as a dongle and is mounted on the main unit or connected to the in-cab socket. Dongle 4a has an ISO client with VT mask and AUX inputs and outputs, which registers on the ISOBUS in accordance with ISO11783. The device 4a, which is designed as a dongle, communicates via WLAN with a mobile terminal 5, which has the appropriate hardware interfaces to establish the connection. The agricultural machine 1 and therefore also the device 4a can be connected to an implement 6 or a working machine via CAN (ISOBUS). The implement 6 has ISOBUS according to ISO 11783 standard.

As an extension, it could communicate with a second device via WLAN, which forwards the inputs from control elements on another machine.

There is an approval process between the mobile end device 5 and the device 4a. The release can be requested, for example, via an app installed on the end device and confirmed or rejected via a user interface (VT mask according to ISO 11783) on the agricultural machine 1. The app also provides a user interface on the mobile end device 5. Alternatively, the user interface can be generated by a web interface. An ECU with AUX outputs is connected to or on the agricultural machine 1.

FIG. 2 shows a schematic communication between a combination. The agricultural machine 1 represents the machine or combination to be controlled (towing vehicle with ISOBUS implement). The agricultural machine 1 can also be referred to as the main unit. A control element 2 can be present on the main unit as an “input unit” (e.g. a joystick), which is also used to control machine functions via ISOBUS. There is also an ISO UT 3, which manages the assignment of AUX inputs and outputs in accordance with ISO 11783. The first device 4a is mounted and connected to the main unit. It has an ISO client with VT mask and AUX inputs and outputs, which logs on to the ISOBUS in accordance with ISO 11783. The first device 4a can communicate with a mobile terminal via WLAN and with the implement 6 via CAN. This first device 4a in the main unit can act as a “master” module.

Furthermore, a second device 4b can be present in a further agricultural machine 1, whereby the devices 4a, 4b communicate via WLAN and the device 4b of the further agricultural machine acts as a “slave” module. The two agricultural machines 1 can be described as a combination. There is a release process between the devices 4a, 4b of the combination. The release is requested and confirmed or rejected via a user interface (VT mask according to ISO 11783) on the main unit. There is an ECU on the main unit or connected to it, which has AUX outputs. There is also a control element 2 on the other agricultural machine 1. The control element 2 of the other agricultural machine 1 can be used to control machine functions on the main unit via a connection of the devices 4a, 4b.

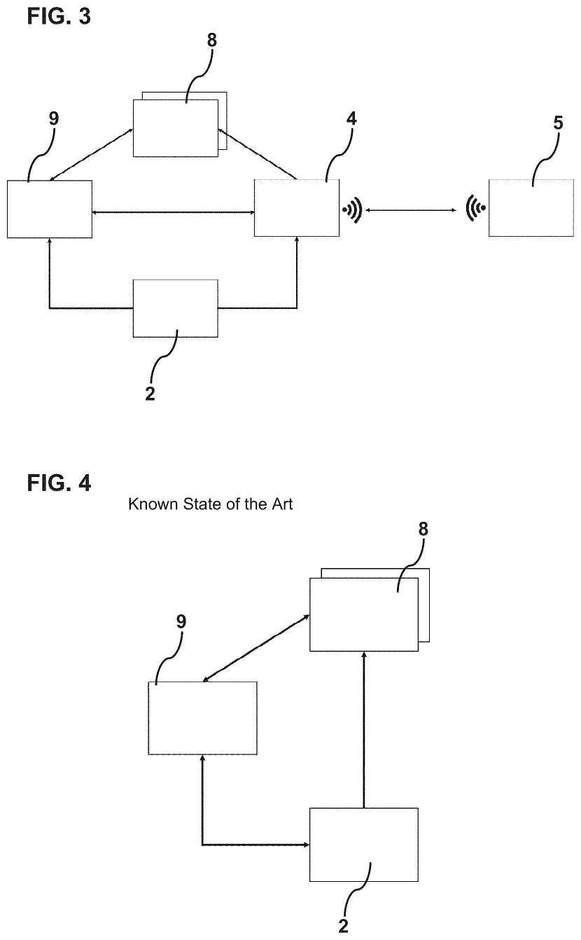

FIG. 3 shows a schematic data flow according to one embodiment of the method. The mobile terminal 5 communicates via WLAN with a CAN-Wifi module 4 of a device that is connected to the agricultural machine and has an ISO client with VT mask and AUX inputs and outputs and registers on the ISOBUS of the agricultural machine in accordance with ISO11783. The CAN Wifi module 4 communicates via CAN (ISOBUS) with one or more ISOBUS ECUs 8. Controls for AUX functions are transmitted via ISOBUS to the ISOBUS ECUs 8 that have AUX functionality. There is also an ISOBUS connection between ISO-UT 9 and ECUs 8. The ECUs 8 are registered as ISOBUS participants with ISO-UT 9. ISO-UT 9 manages the assignment of AUX functions and inputs and displays the ISOBUS user interface on the main unit. There can also be an ISOBUS connection between the ISO-UT 9 and conventional ISOBUS operating elements 2, e.g. a joystick. The ISOBUS joystick 2 can log on to the ISO-UT 9 as a participant in the ISOBUS. There is an ISOBUS connection between CAN-Wifi module 4 and ISOBUS-UT 9, so that the CAN-Wifi module 4 can log on to the ISO-UT 9 as a client with AUX functions and inputs/outputs. Via the ISOBUS connection between control element 2, e.g. the joystick and the CAN-Wifi module 4, AUX inputs of the control element 2 are transmitted to the CAN-WiFi module 4, which also transmits operations of AUX functions via ISOBUS to the ISOBUS ECUs 8.

FIG. 4 shows a schematic data flow according to the state of the art. There is an ISO-UT 9 as an ISOBUS control unit on the agricultural machine. There is an ISOBUS connection between the ISO-UT 9 and a control element 2, e.g. the AUX joystick. Control element 2 logs on to the ISO-UT 9 as a participant with the number of its AUX inputs. There is an ISOBUS connection between control element 2 and ISOBUS-ECUs 8. Input commands from control element 2 are sent to ISOBUS-ECUs 8. The ISOBUS ECU 8 has AUX functions. There is also an ISOBUS connection between ISOBUS ECUs 8 and ISO-UT 9, whereby the ISO-UT 9 manages the assignment of AUX inputs of control element 2 to AUX functions of ISOBUS ECUs 8.

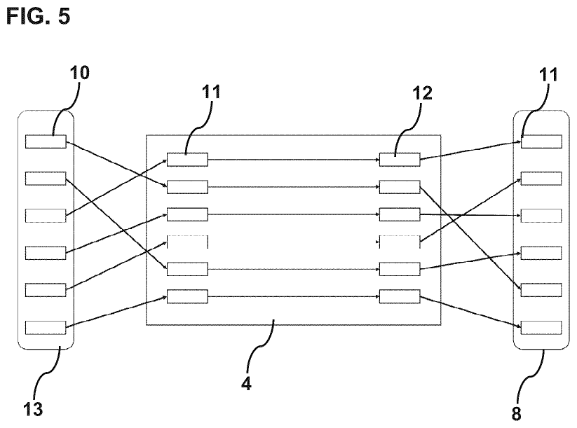

FIG. 5 shows a schematic representation of a multi-assignment. There are several ISOBUS participants 13 with AUX inputs 10 according to ISO 11783 as operating elements. Device 4 establishes the connection to ISOBUS-ECU 8 with AUX functions 11 in accordance with ISO 11783 and assigns these AUX inputs 12 to device 4 in accordance with ISO 11783. This results in AUX inputs 12 according to ISO 11783 of device 4. A function assignment is made via ISOBUS, namely an assignment of control element inputs 10 to AUX functions 11 of device 4 via ISOBUS and assignments of AUX inputs 12 of device 4 to AUX functions 11 of ISOBUS-ECU 8 via ISOBUS. Proprietary assignments can exist between AUX functions 11 and inputs 12.

1. A method for controlling at least one AUX function of an agricultural machine (1) with a first device (4a) comprising a CAN wifi module (7), comprising the steps of:
establishing a data-exchanging connection between the first device (4a) and the agricultural machine (1), the CAN wifi module (7) registering as an ISOBUS client with VT mask and AUX inputs and outputs on the ISOBUS of the agricultural machine in accordance with ISO11783,
a WLAN connection is established to a mobile terminal (5) with a user interface for displaying machine-specific information and inputting machine-specific commands, or a WLAN connection is established to a second device (4b) on another agricultural machine (1) with a user interface for displaying machine-specific information and inputting machine-specific commands,
inputs on the user interface are transmitted to the CAN-Wifi module (7) via the WLAN connection, and
the CAN-Wifi module (7) generates a machine-specific command in accordance with ISO11783 on the ISOBUS and triggers AUX functions on the agricultural machine (1).

2. The method according to claim 1, wherein the triggering of AUX functions on the agricultural machine (1) is enabled.

3. The method according to claim 2, wherein the release is granted once per existing connection.

4. The method according to claim 1, wherein single assignment functions of an operating element (2) of the agricultural machine (1) are assigned to corresponding AUX inputs and outputs of the CAN wifi module (7), so that an input at the operating element (2) triggers an input at the CAN wifi module (7) and leads to a machine-specific command.

5. The method according to claim 1, wherein the CAN wifi module (7) simulates the registration of an implement (6) with corresponding outputs on the ISOBUS, so that physical inputs are assigned to simulated outputs.

6. The method according to claim 1, wherein the device (4a, 4b) records and repeatedly carries out an input of machine-specific commands made via the user interface.

7. A system for carrying out the method according to claim 1, having at least one agricultural machine (1), a first device (4a) and a second device (4b) or a mobile terminal (5) with a user interface for displaying machine-specific information and inputting machine-specific commands, which have hardware interfaces for data-exchanging communication and the devices (4a, 4b), which comprise a CAN wifi module (5), are connected or can be connected to at least the one agricultural machine (1).

8. The system according to claim 7, wherein an ISOBUS client with VT mask and AUX inputs and outputs are located on the device (4a, 4b).

9. The system according to claim 7, wherein the device (4a, 4b) comprises a programmable computing unit.

10. The system according to claim 7, wherein the device (4a, 4b) comprises at least one WLAN interface for data-exchanging communication with a mobile terminal (5).

11. The system according to claim 7, wherein the system comprises a mobile terminal (5).
